(19) United States
(12) Patent Application Publication
(10) Pub. No.: US 2016/0036739 A1
(43) Pub. Date: Feb. 4, 2016

(54) THANK YOU MESSAGE PROCESSING SYSTEM AND METHOD FOR ONLINE GIFTING

(71) Applicant: GIFT CARD IMPRESSIONS, LLC, Kansas City, MO (US)

(72) Inventors: Brett R. Glass, Kansas City, MO (US); Nicole E. Glass, Kansas City, MO (US); Karl Joseph Geisler, Kansas City, MO (US); Dominique Michelle Pierron O'Hara, Kansas City, MO (US)

(21) Appl. No.: 14/814,207

(22) Filed: Jul. 30, 2015

Related U.S. Application Data
(60) Provisional application No. 62/030,719, filed on Jul. 30, 2014.

(51) Int. Cl. H04L 12/58; H04W 4/12; G06Q 30/06

(52) U.S. Cl. CPC H04L 51/046; G06Q 30/06; H04W 4/12

(57) ABSTRACT

A thank you message generation system includes a server that functions with a recipient computing device to generate a graphical user interface (GUI) on a display of the recipient computing device to receive gratitude information directed to a giver of a gift in which the gift received via a gift message received by the recipient computing device. The server extracts at least one element of gift information from the received gift message, generates a thank you message using the gratitude information and the gift information, and transmits the thank you message to a giver computing device of the giver.

### RELATED APPLICATIONS

This application takes priority to U.S. Patent Application Ser. No. 62/030,719, and entitled “Thank You Message Processing System and Method For Online Gifting.” The contents of 62/030,719 is hereby incorporated by reference in its entirety.

### FEDERALLY SPONSORED RESEARCH OR DEVELOPMENT

Not Applicable.

### COMPACT DISK APPENDIX

Not Applicable.

### BACKGROUND

Online shopping (e.g., e-shopping) is a form of electronic commerce that allows givers to purchase goods from a merchant over the Internet. A particular type of online shopping that has recently seen relatively large growth includes online gift purchases. For example, digital gift cards (e.g., e-gift cards) or other types of digital transaction value cards have become a popular gifting means due to their relatively ease of use. Giver satisfaction for online gift purchases, however, is hampered due to lack of communication between the giver and recipient of the gift. For example, givers of online gifts often do not receive feedback for gifts from the recipients of these gifts in a timely manner, and if any is provided, it is provided via a differing medium (e.g., phone call session, personal contact, etc.) from that used to deliver the gift to the recipient. It is with these issues in mind, among others, that various aspects of the present disclosure were conceived.

### SUMMARY

According to one embodiment of the present disclosure, a thank you message generation system includes a server that functions with a recipient computing device to generate a graphical user interface (GUI) on a display of the recipient computing device to receive gratitude information directed to a giver of a gift in which the gift received via a gift message received by the recipient computing device. The server extracts at least one element of gift information from the received gift message, generates a thank you message using the gratitude information and the gift information, and transmits the thank you message to a giver computing device of the giver.

### BRIEF DESCRIPTION OF THE DRAWINGS

FIG. 1A is a block diagram of a computing system that includes a thank you message processing system according to one embodiment of the present disclosure.

FIG. 1B depicts an exemplary embodiment of a computing device according to according to one embodiment of the present disclosure.

FIG. 1C depicts an exemplary embodiment of a data source according to an according to one embodiment of the present disclosure.

FIG. 2 is a block diagram of a computing system that includes a thank you message processing application according to according to one embodiment of the present disclosure.

FIG. 3 is a flowchart depicting a process for creating a personalized thank you message according to according to one embodiment of the present disclosure.

FIG. 4 illustrates an example splash screen that is generated by the application according to one embodiment of the present disclosure.

FIG. 5 illustrates an example template selection screen that is generated by the application according to one embodiment of the present disclosure.

FIG. 6 illustrates an example front message customization screen that is generated by the application according to one embodiment of the present disclosure.

FIG. 7 illustrates an example inside message customization screen that is generated by the application according to one embodiment of the present disclosure.

FIG. 8 illustrates an example thank you message preview screen that is generated by the application according to one embodiment of the present disclosure.

FIG. 9 illustrates an example envelope type selection screen that is generated by the application according to one embodiment of the present disclosure.

FIG. 10 illustrates an example envelope inner liner selection screen that is generated by the application according to one embodiment of the present disclosure.

FIG. 11 illustrates an example reveal video preview/selection screen that is generated by the application according to one embodiment of the present disclosure.

FIG. 12 illustrates an example delivery medium type selection screen that is generated by the application according to one embodiment of the present disclosure.

FIG. 13 illustrates an example giver information entry screen that is generated by the application according to one embodiment of the present disclosure.

FIG. 14 illustrates an example recipient financial account information entry screen that is generated by the application according to one embodiment of the present disclosure.

FIG. 15 illustrates an example checkout information entry screen that is generated by the application according to one embodiment of the present disclosure.

FIG. 16 illustrates an example confirmation screen that is generated by the application according to one embodiment of the present disclosure.

### DETAILED DESCRIPTION

Although online gifts have become a commonly accepted gifting medium, their use has not been without limitation. For example, conventional online gift delivery systems, such as email messaging or text messaging, often do not provide any mechanism for the recipient of the gift to convey gratitude or other forms of positive sentiment to the giver for receipt of the gift. Embodiments of the present disclosure provide a solution to this problem using an application executed on a computing device that functions with an online gifting platform of a merchant to generate a thank you message using information provided by a recipient of the online gift. The thank you message serves as a mechanism for conveying user-supplied gratitude information back to the giver of the gift as well as confirmation to the giver that the gift was actually received by the recipient. Additionally, the thank you message generating platform may be implemented as a portion of an online gift processing system, and/or serve as a mechanism for use by other third party online gift processing platforms.

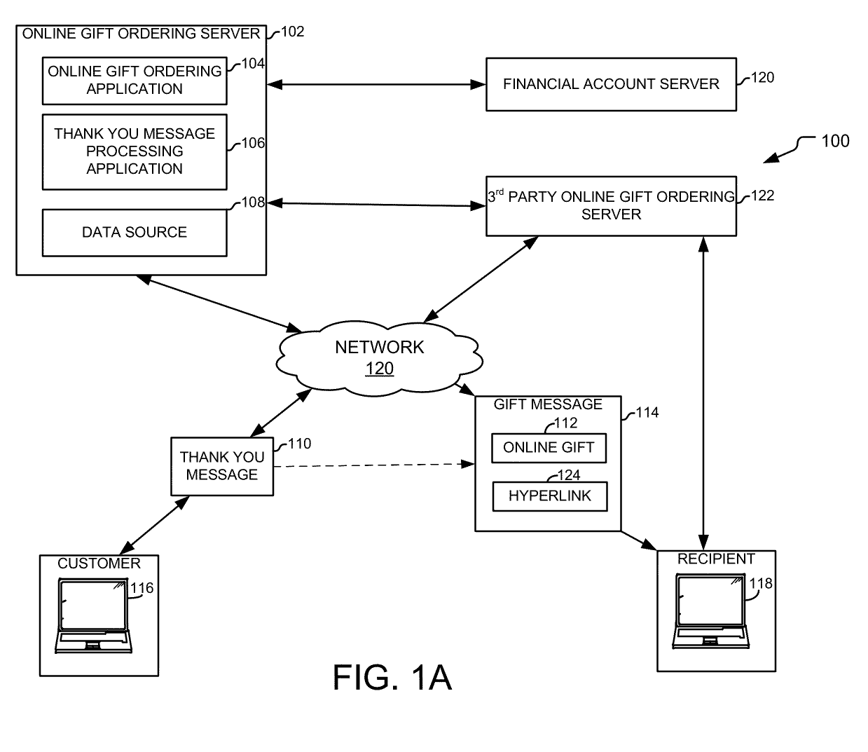

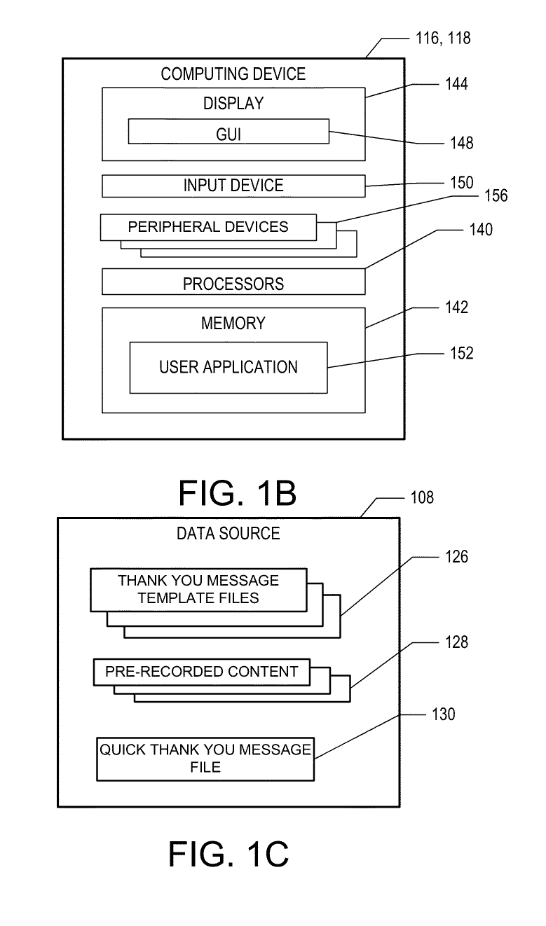

FIGS. 1A through 1C depict an example thank you message processing system 100 according to aspects of the disclosure. The system 100 includes an online gift ordering server 102 that includes an online gift ordering application 104, a thank you message processing application 106 and a data source 108. As will be described in detail below, the thank you message processing application 106 generates a thank you message 110 in accordance with a gift 112 received by a recipient for transmission to a giver computing device 116 associated with a giver of the gift 112. The thank you message 110 is generated from user-supplied information received from a recipient via a recipient computing device 118.

The user-supplied information may include any type of information, such as user-supplied content (e.g., audio (e.g., sound) content, textual content, photographic content, video content, etc.), that is used to provide a personal sentiment for conveying gratitude to the giver for receipt of the gift. For example, the thank you message 110 may be populated with textual content including a phrase, such as a personal term of endearment that is commonly known between the giver and recipient for personalization of the thank you message 110. As another example, the thank you message 110 may be populated with a photograph depicting a commemorable moment that was shared between the giver and the recipient to enhance the sentiment conveyed by the thank you message 110.

The gift 112 may be provided to the recipient using a gift message 114, which may be, for example, an email message transmitted over the Internet, or a short messaging service (SMS) or multimedia messaging service (MMS) message transmitted over a wireless telephone network. The online gift 112 given to the recipient may be any type, such as a physical gift in which the gift message 114 includes an indication of the gift, or a digital gift, such as an electronic gift card (e.g., e-gift card) or other type of digital medium storing a specified amount of monetary value.

Certain embodiments of the present disclosure provide advantages not heretofore recognized by conventional online gifting systems. For example, the thank you message processing system 100 provides an efficient mechanism for conveying gratitude to the giver from the recipient using the same or similar platform from which a gift was delivered to the recipient. For example, the online gift ordering application 104, which processes orders for online gifts, may also include the thank you message processing application 106 for generating thank you messages sent to the giver of these online gifts. Additionally, coupling of the online gift ordering application 104 and thank you message processing application 106 may provide the ability to include detailed information associated with the online gift, such as via extraction of information included in the gift message 114 and/or gift included in the gift message 114.

In general, the thank you message processing application 106 functions with a locally administered online gift ordering application 104 or another third party online gift ordering server 122 that processes and transmits the gift message 114 and associated gift 112 to a recipient computing device 118 of a selected recipient, and processes the generation of a thank you message 110 to be transmitted back to the giver computing device 116 in response to receipt of the gift 112. Because the thank you message processing application 106 functions with online gift processing systems such as these, detailed information associated with the processed gift may be used for enhanced personalization of the thank you message 110 sent back to the giver. For example, the thank you message processing application 106 may include information associated with the gift itself (e.g., an image of the gift), and/or information associated with the type of gift (e.g., occasion associated with the gift), and/or giver contact information (e.g., email address, phone number) that may ease completion of the thank you message 110 by the recipient.

The thank you message processing system 100 according to the teachings of the present disclosure may be used in conjunction with any suitable online gifting platform that markets and sells any type of gift that is digitally transmitted to a recipient. For example, the online gift ordering application 104 may include a stored value card activation application that conducts a financial transaction for a stored value card with a giver, and facilitates transmission of the stored value card to a recipient selected by the giver. Additional details related to the stored value card ordering system is described in U.S. Provisional Patent Application Ser. No. 61/737,731, filed Dec. 14, 2012, and entitled “Online Personalized Gifting System,” which is a continuation in part of application Ser. No. 13/273,220, filed Oct. 13, 2011, and entitled “Online Personalized Gifting System.” The contents of 61/737,731and Ser. No. 13/273,220 are both incorporated herein by reference in their entirety.

The locally administered online gift ordering application 104 generally refers to one that is administered by the same entity (e.g., merchant) that administers the thank you message processing application 106, while a third party online gift ordering server 122 generally refers to one that is administered by a different entity from that administering the thank you message processing application 106. For example, a locally administered online gift ordering application 104 may be administered by a particular merchant that hosts a website for processing online orders using the online gift ordering application 104 and the thank you message processing application 106. As another example, a third party online gift ordering server 122 may be administered by a first entity, while the thank you message processing application 106 is administered by another different entity that is separate and distinct from the first entity.

In a particular embodiment, the third party online gift ordering server 122 may facilitate interaction with the recipient computing device 118, while the application 104 exposes one or more application program interfaces (APIs) to the third party online gift ordering server 122 for providing the features of the thank you message processing messaging system 100 described herein. In one embodiment, the application 104 is implemented in a service oriented architecture (SOA) such that the third party online gift ordering server 122 accesses the features of the application 106 as independently functioning services conforming to a web services description language (WSDL) protocol. Nevertheless, any suitable type communication protocol between the third party online gift ordering server 122 and the application 106 may be used for facilitating the thank you message processing messaging platform.

In one embodiment, the thank you message processing application 106 communicates with a recipient financial account server 120 associated with the recipient to process a monetary transaction for use of the thank you messaging service. That is, the thank you message processing application 106 conducts a monetary transaction via a recipient financial account server 120 of the recipient to pay for generation of the thank you message 110, transmission of the thank you message to the giver of the online gift 112. In other embodiments, the thank you message processing application 106 may conduct the thank you messaging service free of charge for the recipient of the online gift.

Examples of the online gift ordering server 102, third party online gift ordering server 122, and recipient financial account server 120 include one or more servers, personal computers, mobile computers and/or other mobile devices, and other computing devices. The server 102 may communicate via wireless, wireline, and/or optical communications. The online gift ordering server 102, third party online gift ordering server 122, and recipient financial account server 120 have one or more processors and executable instructions stored in volatile and/or non-volatile memory for performing the actions and/or steps described herein.

The data source 108 stores information that is used for generating thank you that are sent by the recipient, such as one or more thank you message template files 126, one or more pre-recorded content files 128, and quick thank you message file 130. The thank you message template files 126 stores one or more templates that may be selected and customized by the recipient using content stored in the pre-recorded content files 128, or other user-supplied content provided by the recipient. The pre-recorded content files 128 stores content, such as textual, images, audio, and/or video content that may be selected by the giver for inclusion in a selected one of the thank you message templates. Although the data source 108 is shown as being located on, at, or within the local server 102, it is contemplated that the data source 108 can be located remotely from the local server 102 in other aspects of the system 100, such as on, at, or within a database of a data management system or a database of another computing device or system having at least one processor and volatile and/or non-volatile memory.

The communication network 120 can be the Internet, an intranet, or another wired and/or wireless communication network. In one aspect, the server 102, giver computing device 116, recipient computing device 118, and the third party online gift ordering server 122 communicate with one another using any suitable protocol or messaging scheme. For example, server 102, giver computing device 116, recipient computing device 118, and the third party online gift ordering server 122 communicates using a Hypertext Transfer Protocol (HTTP), extensible markup language (XML), extensible hypertext markup language (XHTML), or a Wireless Application Protocol (WAP) protocol. Other examples of communication protocols exist. Although the example of FIG. 1A shows server 102, giver computing device 116, recipient computing device 118, and the third party online gift ordering server 122 communicate with one another through a network, other embodiments contemplate the server 102 communicating directly with the recipient computing device 118 without the use of a separate and a distinct network. Additionally, other embodiments contemplate that the modules employed by the server 102 and the giver computing device 116 are integrated in one computing system.

The user accesses the system 100 via the giver computing device 116 hosted by the online gift ordering server 102 using an HTML link or other suitable entry point, such as through application software (i.e., a mobile app) executed on a portable computing device, such as a wireless communication device. The thank you message processing application 106 uses the information provided by the giver to generate the thank you messages and transmits the messages to the giver computing device 116. The thank you messages may be digitally transmitted to the recipient using an e-mail message, a short message service (SMS), a multimedia messaging service (MMS), via a social media account, or other suitable digital communication medium.

FIG. 1B depicts an example embodiment of a giver computing device 116 or recipient computing device 118 according to one aspect of the thank you message processing system 100. The computing device 116, 118 is a computing or processing device that includes one or more processors 140 and memory 142. For example, the computing device 116, 118 can be a personal computer, such as a laptop or notebook computer, a workstation, or other processing device such as a personal digital assistant or a tablet computer. The computing device 116, 118 includes a display 144, such as a computer monitor, for displaying data and/or a graphical user interface 148. The computing device 116, 118 also includes an input device 150, such as a keyboard or a pointing device (e.g., a mouse, trackball, pen, or touch screen) to enter data into or interact with the graphical user interface 148. In one embodiment, the display 144 comprises a touch-screen device in which input is provided via contact by the user with the touch-screen device. The computing device 116, 118 receives data and/or communications from, and/or transmit data and/or communications to, the server 102 via the communication network 120.

The computing device 116, 118 includes a user application 152 stored in the memory 142 and executed on the processors 140 to generate the graphical user interface (GUI) 148 to the display 144. The graphical user interface 148 enables the recipient computing device 118 to interact with one or more data entry forms received from the server 102 to enter configuration parameters for the thank you messages, and/or customization data for customizing the thank you messages. In one embodiment, the user application 152 includes a web browser that displays interactive web pages, one or more applets, or other suitable user interface mechanisms including one or more selectable fields, editing screens, and the like for selecting content and/or modifying pre-recorded content by the recipient. In another embodiment, the GUI application 152 includes application software (i.e., a mobile app) that is executed on the recipient computing device 118 which is, for example, a wireless communication device for providing one or more selectable fields, edit screens, and the like for selecting content and/or modifying pre-recorded content by the user.

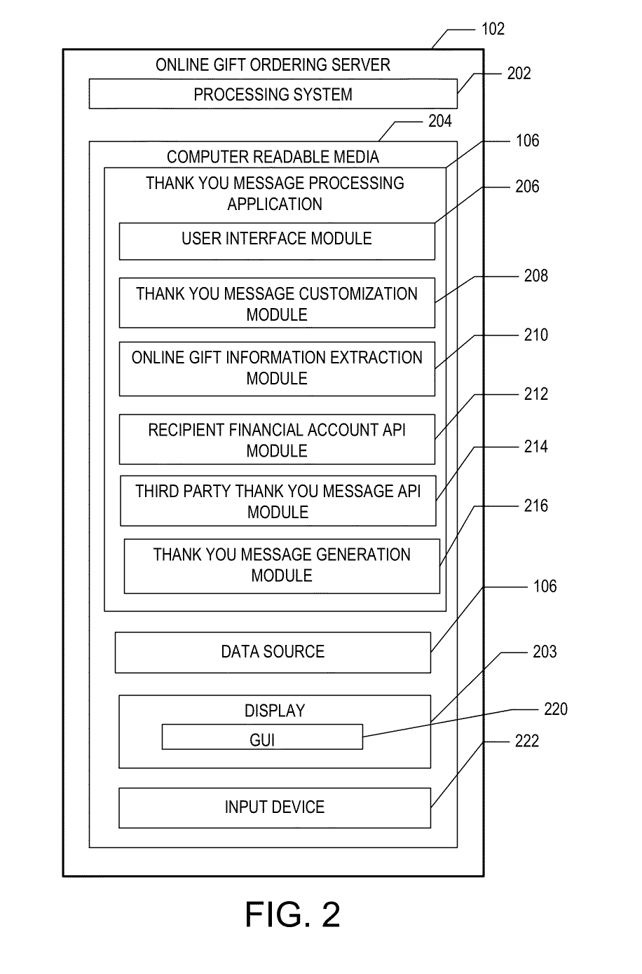

FIG. 2 is a block diagram depicting an example thank you message processing application 106 executed on the online gift ordering server 102. According to one aspect, the online gift ordering server 102 includes a processing system 202 that includes one or more processors or other processing devices. A processor is hardware. The processing system 202 executes the thank you message processing application 106 to generate the GUI 148 on the recipient computing device 118 for receiving thank you message information for generating the thank you messages by the recipient. According to another aspect, the online gift ordering server 102 also includes a display 203, such as a computer monitor, for displaying data and/or a graphical user interface 220. The gift card activation server 202 also includes an input device 222, such as a keyboard or a pointing device (e.g., a mouse, trackball, pen, or touch screen) to enter data into or interact with the graphical user interface 220.

According to one aspect, the online gift ordering server 102 includes a computer readable medium 204 configured with the thank you message processing application 106. The thank you message processing application 106 includes instructions or modules that are executable by the processing system 202 to generate a customized thank you message to be sent to a recipient along with a selected gift card.

The computer readable medium 204 includes volatile media, nonvolatile media, removable media, non-removable media, and/or another available medium that can be accessed by the online gift ordering server 102. By way of example and not limitation, computer readable medium 204 comprises computer storage media and communication media. Computer storage media includes non-transient storage memory, volatile media, nonvolatile media, removable media, and/or non-removable media implemented in a method or technology for storage of information, such as computer readable instructions, data structures, program modules, or other data. Communication media embodies computer readable instructions, data structures, program modules, or other data and include an information delivery media or system.

A user interface module 206 facilitates the receipt of data and/or other communications from the recipient computing device 118. In one example, the user interface module 206 communicates with the recipient computing device 118 using a web browser executed on the recipient computing device 118 to provide one or more selectable fields, editing screens, and the like for receiving content and/or modifying pre-recorded content by the giver. In another example, the user interface module 206 communicates with the recipient computing device 118 using application software (i.e., a mobile app) executed on the recipient computing device 118, such as a wireless communication device or tablet computer, to provide one or more selectable fields, editing screens, and the like for receiving content and/or modifying pre-recorded content by the giver. In yet another example, the user interface module 206 communicates with one or more peripheral devices 156 of the computing device 1×× to receive user-supplied content to be included in the thank you messages.

A thank you message customization module 208 manages customization of thank you messages. For example, the thank you message customization module 208 receives personalized content generated by a recipient and processes the received user-supplied content to generate customized content to be included in the thank you message. For another example, the thank you message customization module 208 receives user selection of a thank you message template including a particular design, such as one associated with a special occasion associated with the gift, such as, for example, a birthday, wedding, or a holiday, such as Christmas, Easter, Thanksgiving, and the like.

The module 208 may customize the thank you message in any suitable manner. For example, the module 208 may composite or render user-supplied content, such as a photograph in a first pre-defined field of a thank you message template file 126, and/or a text message in a second pre-defined field of the thank you message template file 126. Examples of compositing the photograph may include sizing (e.g., shrinking or enlarging), or cropping the photograph to fit within a specified region of the template file 126, or color adjusting the photograph to have a certain hue that comports with the overall theme of the template file 126. Example of compositing a text message may include adjusting a font, a size, or other feature of a text message provided by the user to meet certain constraints of the pre-defined field, such as a maximum size of the overall text message, a maximum number of characters, and the like.

The application 106 also provides for selection of pre-recorded content stored in the data source 108, such as the pre-recorded content files 128. In a particular embodiment, the pre-recorded content includes a song or a portion of a pre-recorded song that is copyrighted and licensed by the owner of the copyrighted song. The thank you message customization module 208 modifies existing content, such as pre-recorded content or other previously received content, based upon input received from the giver computing system 116. An example of modifying existing content includes modifying a received photograph using one or more photograph editing features that provides for cropping, color hue adjustment, brightness adjustment, sizing, and/or other features associated with manipulation of digital imagery.

An online gift information extraction module 210 obtains content to be included in the thank you message from either or both of the online gift 112 and/or gift message 114 used to convey the gift to the recipient. For example, the online gift information extraction module 210 may extract an image of the gift conveyed in the gift message for inclusion in the thank you message. Using this example in which the gift comprises a merchant gift card, the online gift information extraction module 210 may generate an image of a merchant gift card representing the merchant gift card and include the merchant gift card image in the thank you message such that, when viewed by the giver, the merchant gift card image serves to enhance an awareness that the recipient appreciated receipt of the gift. As another example, the online gift information extraction module 210 may extract address information (e.g., email address, phone number, etc.) associated with the giver from the gift message 114. In this manner, the recipient may be alleviated from manually entering address information of the giver, while ensuring that the same address used to send the gift is also used for sending the thank you message. As yet another example, the online gift information extraction module 210 may extract occasion information from the gift message 114 or gift 112 and include the occasion information in the thank you message 110. For example, if the gift message includes occasion information, such as that the gift is given due to a birthday of the recipient, the online gift information extraction module 210 may include birthday information in the thank you message, such as “My birthday was great; I'm one year older, yet feel the same.”

A recipient financial account API module 212 communicates with a payment processing server, such as the recipient financial account server 120, to transact a monetary transfer of funds from the recipient's financial account to a financial account of an entity administering operation of the online gift ordering system for generating and transmitting the thank you message to the giver of the gift. For example, the recipient financial account API module 212 may communicate with a recipient financial account server 120 associated with an account of the recipient, such as PAYPAL™ account, a VISA™, account, a DISCOVER™ account, and the like. Nevertheless, the recipient financial account API module 2×× may not be implemented if no financial transaction for use of the thank you message generating system is needed or desired.

A third party thank you message application program interface (API) module 214 exposes one or more interfaces for use by other online gift platforms managed by other merchants. For example, a server managed by a merchant, which is separate and distinct from the merchant managing the server 102, may access the application 106 via the third party thank you message API module 214 to implement thank you messages for online gifts purchased of it products sold through its online gift ordering system. The API modules may also include one or more financial transaction hooks for facilitating payment for the services provided by the system, such as via a per use basis or via a monthly subscription.

A thank you message generation module 216 facilitates the generation of the thank you messages, and transmission of the generated thank you message 110 to the giver computing device 116. In one example, the thank you message is generated in digital form and transmitted to the recipient via any suitable communication mechanism, such as via an e-mail message, or a short message service (SMS) message.

It should be appreciated that the modules described herein is provided only as an example of a computing device that executes the thank you message processing application 106 according to the teachings of the present invention, and that other computing systems may have the same modules, different modules, additional modules, or fewer modules than those described herein. For example, one or more modules as described in FIG. 2 is combined into a single module. As another example, certain modules described herein is encoded on, and executed on other computing systems, such as the recipient computing device 118.

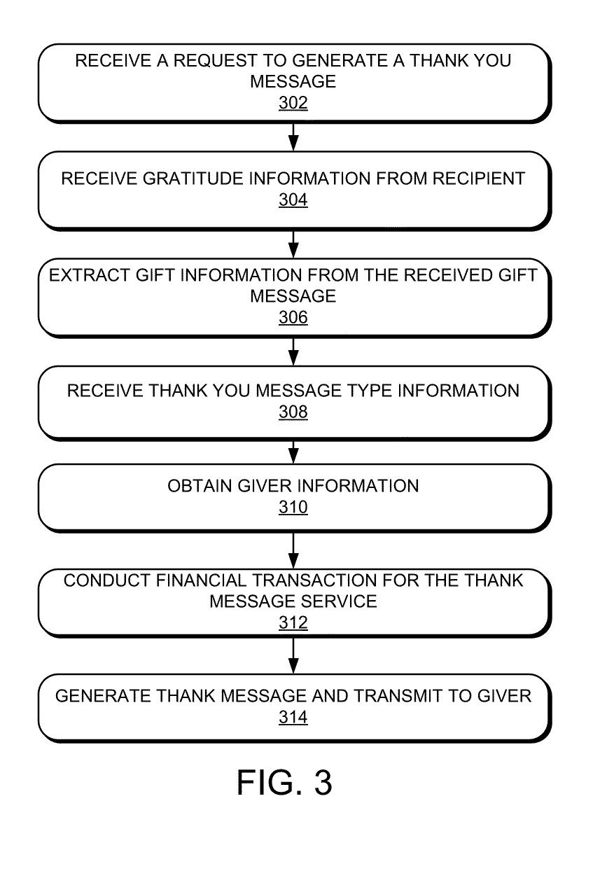

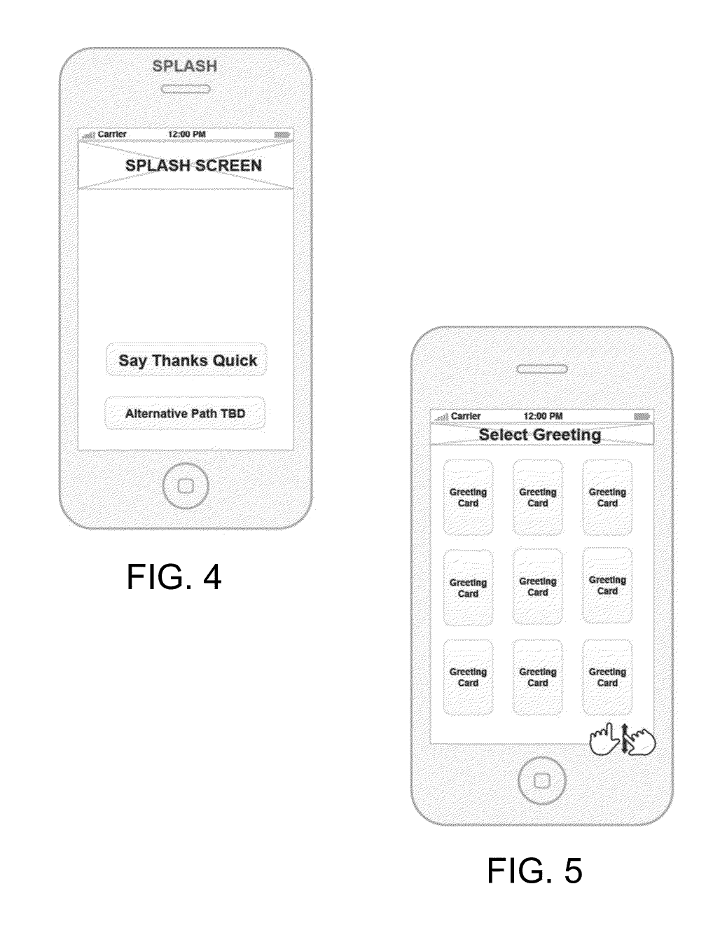

FIG. 3 illustrates an example process that is performed by the thank you message processing application 106 according to the teachings of the present disclosure. As shown and described herein, FIGS. 4 through 16 depict various screens that may be generated by a mobile app on a portable computing device, such as a smart phone or a tablet computing device. Nevertheless, is should be understood that the steps of the process described herein may also be applied to other applications executed on the recipient computing device 118, such as a web browser executing instructions received via the gift message 114.

In step 302, the thank you message processing application 106 receives a request from the recipient computing device 118 to generate a thank you message 110. In one embodiment, the request is initiated by selecting, by the recipient, a hyperlink 124 included in the gift message 114. The hyperlink 124 may trigger executable code executed on the recipient computing device 118 for communicating with the application 106. For example, the executable code may include an applet that is included with the gift message 114 sent to the recipient computing device 118, or the executable code may be a mobile app executed on a portable computing device, such as a smart phone or a tablet computer.

In a particular example, the application 106 may generate a splash screen (FIG. 4) that displays one or more user selected paths for generating and sending the thank you message. As shown, the splash screen includes a quick thank you message generation button and a customized thank you note generation button. Whereas the quick thank you message button causes the application to access the quick thank you message file 130 stored in the data source 108 for delivery to the giver, the customized thank you message generation button causes the application 106 to access one of the thank you message templates 126 for further customization by the recipient.

In step 304, the application 106 receives gratitude information from the recipient computing device. In one embodiment, the application 106 receives gratitude information from the recipient via the recipient computing device 118. The thank you message processing application 106 provides a mechanism for generating thank you messages that includes personalized content by uploading one or more photographs, customized text messages such as a greeting, add pre-recorded songs and/or sound or voice messages and include this content with the thank you messages.

In step 306, the application 106 receives gift information from either of the gift message 114 and/or the gift included in the gift message 114 for inclusion in the thank you message 110. For example, the application 106 may obtain gift information from the gift message to be included in the thank you message 110. As another example, the application 106 may obtain any occasion information included in the gift message 114 to be included in the thank you message 110. To receive thank you message information from the recipient computing device 118, the application may generate a template selection screen (FIG. 5) that displays a downsized pictorial representation of multiple thank you message templates from which one may be selected by the recipient for further customization.

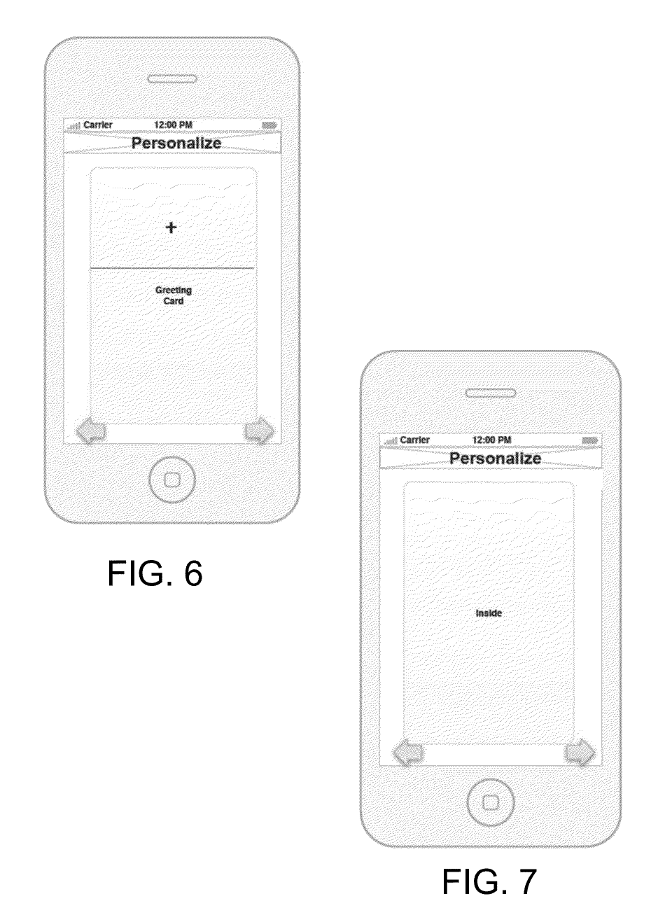

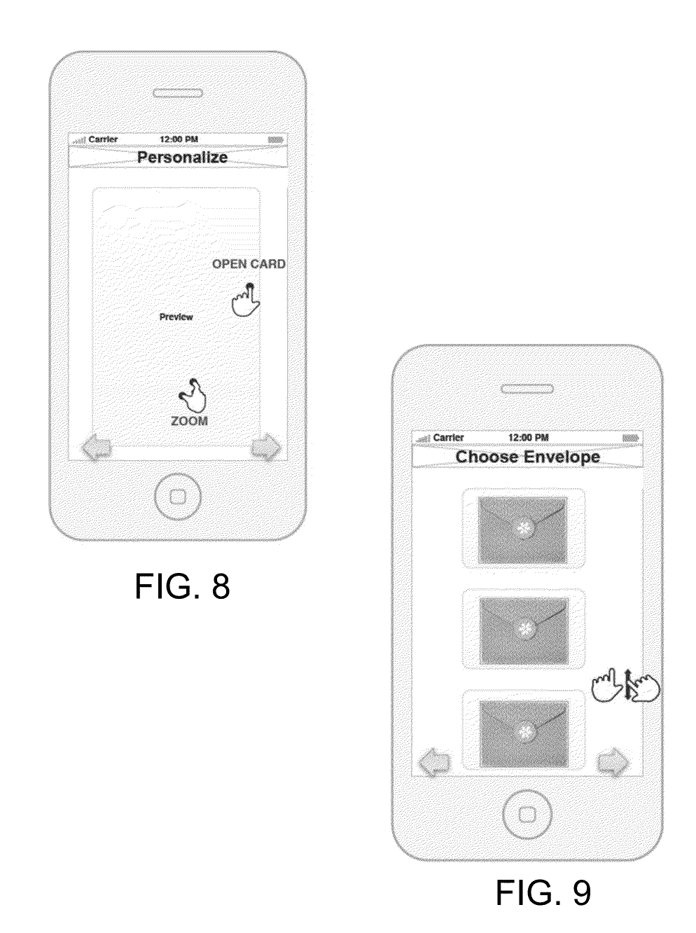

Once a thank you message template has been selected, the application 106 may then generate one or more thank you message template customization screens. For a particular type of thank you message template that simulate a greeting card that is folded to form a front side and inside surfaces, the application may generate a front side thank you message customization screen (FIG. 6) and/or an inside thank you message customization screen (FIG. 7) that allows the recipient to enter user-supplied content or pre-recorded content 128 on a front side or inside of the thank you message template 126, respectively. Once the content is uploaded and/or selected by the recipient, the application 106 may generate a preview screen (FIG. 8) to display what the thank you message will look like when received and viewed by the giver.

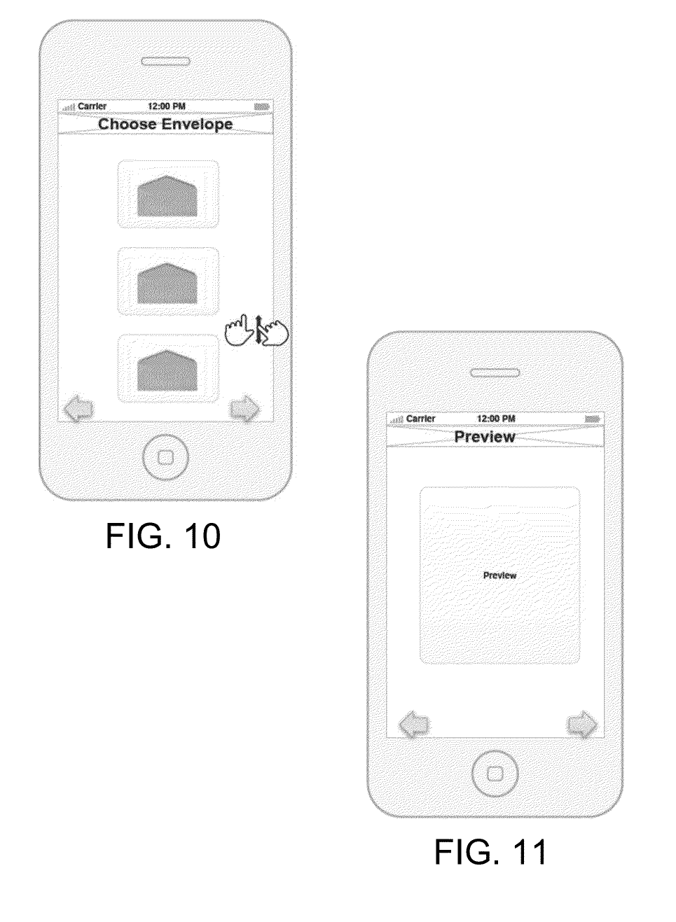

In one embodiment, the thank you message may include a simulated envelope to hold and contain the thank you message 110. Embodiments incorporating a thank you message that is packaged in a simulated envelope may enhance the look and feel of the thank you message sent to the giver by increasing the perception of an actual greeting card provided to the giver. In this particular embodiment, the application 106 may generate an envelope type selection screen (FIG. 9) that display downsized pictorial representations of various types of envelopes that may be selected for inclusion with the thank you message by the recipient. Additionally, the application 106 may generate an inner liner selection screen (FIG. 10) that allows the recipient to select one from among multiple differing types of simulated inner liners of the selected simulated envelope selected via the envelope type selection screen.

In another embodiment, the application 106 may provide for selection of a reveal video or other type of image to be displayed when the thank you message is revealed to the giver. For example, the application 106 may generate a reveal video preview/selection screen (FIG. 11) that provides for selection and preview of a reveal video to be included in the thank you message delivered to the giver.

The reveal video may include any type of pictorial information, such as a still image or an animated moving image, such as an animated animal or other type of moving figure that performs a specified movement to open the envelope for revealing the thank you message. Additional details related to various types of reveal videos are described in U.S. patent application Ser. No. 14/231,349, filed Mar. 31, 2014, and entitled “System and Method For Digital Delivery of Reveal Videos For Online Gifting,” the contents of which is incorporated herein by reference in its entirety.

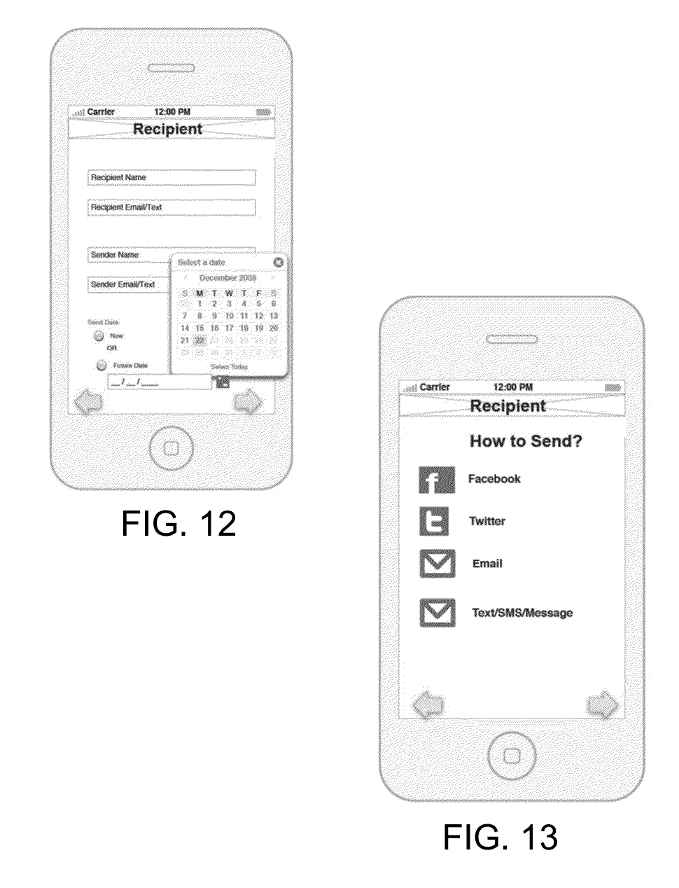

In step 308, the application 106 receives message type information from the recipient computing device 118. For example, the application 106 may generate a message delivery medium type entry screen (FIG. 12) for receiving message delivery medium type information, such as whether the thank you message is to be delivered using a Facebook message, a twitter message, an email message, or a SMS/MMS message (e.g., a text message). Further, the application 106 receives giver information including a name of the giver and an address from which to transmit the generated thank you message by generating a giver information entry screen (FIG. 13) in step 310. In one embodiment, the application 106 obtains the message delivery medium type information and giver information from the gift message 114 received from the giver. For example, the application 106 may extract the source address field of an email message comprising the gift message and use this address for transmitting the thank you message back to the giver. As another example, the application 106 may extract a name of the giver from the gift message 114 and include this name in a text message included in the thank you message, such as “John, thank you for your online gift card,” where the name “John” was extracted from the gift message 114 and included with the phrase “, thank you for your online gift card.”

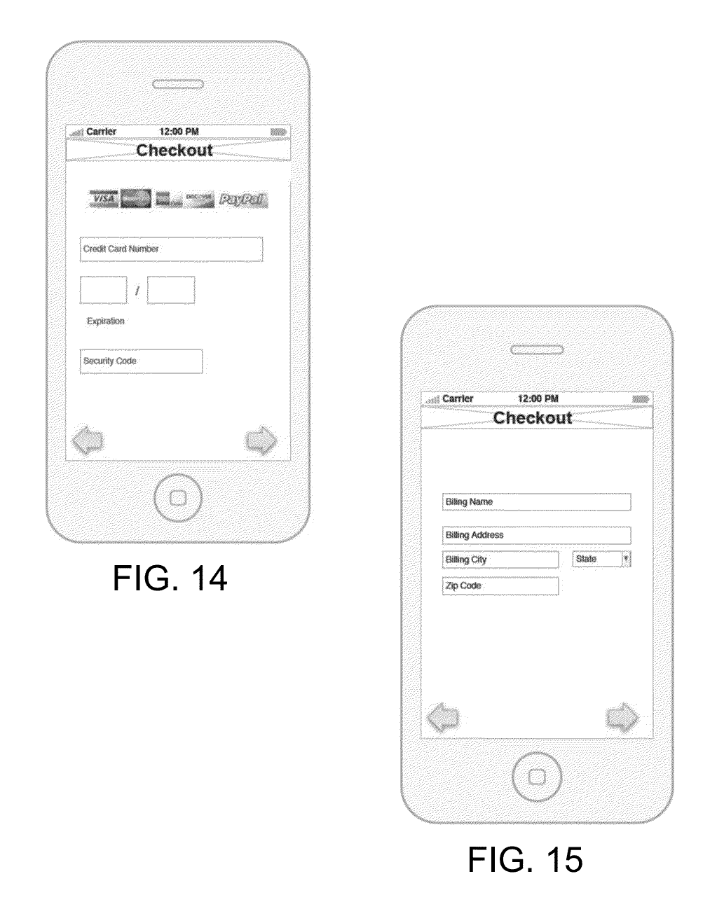

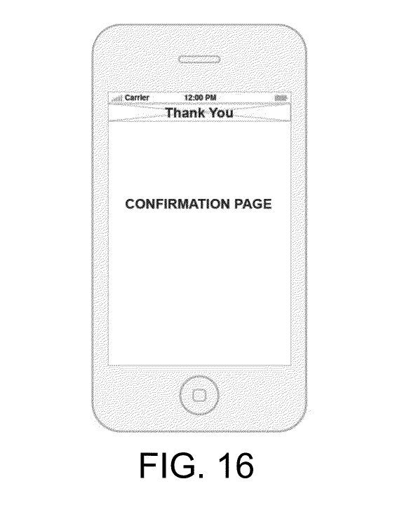

In step 312, the application 106 conducts a financial transaction with the recipient for generating and sending the thank you message to the giver. For example, the application 106 may generate a recipient financial account information entry screen (FIG. 14) and/or a checkout information entry screen (FIG. 15) to receive financial account information from the recipient for payment for the thank you messaging service. Nevertheless, the application 106 may omit the recipient financial account information entry screen (FIG. 14) and/or a checkout information entry screen (FIG. 15) if payment for the thank you messaging service is not needed or desired. When the financial transaction has been completed, the application 106 may then generate a confirmation screen (FIG. 16) indicating to the recipient that that order has been consummated.

In step 314, the application 106 generates the thank you message using the thank you message information, address type information, giver information, and recipient financial information obtained in steps 204 through 312, and transmits the thank you message 110 to the giver of the gift. Nevertheless, when step 314 has been performed by the application 106, the process ends.

It should be appreciated that the steps described herein is provided only as an example of a process that is performed by the online delivery confirmation application 106 according to the teachings of the present invention, and that the online delivery confirmation application 106 may perform fewer, more, or different types of steps than those described herein. For example, the thank you message processing application 106 performs multiple steps described above as a single step. As another example, certain steps described herein is performed by other components of the thank you message processing system 100, such as by the recipient computing device 118 owned by the user.

Those skilled in the art will appreciate that variations from the specific embodiments disclosed above are contemplated by the invention. The invention should not be restricted to the above embodiments, but should be measured by the following claims.

What is claimed is:

1. A thank you message generation system comprising:
a server comprising at least one memory for storing a thank you message processing application that is executed on at least one processor to:
generate a graphical user interface (GUI) on a display of a recipient computing device of a recipient to receive gratitude information directed to a giver of a gift, the gift received via a gift message received by the recipient computing device;
extract at least one element of gift information from the received gift message;
generate a thank you message using the gratitude information and the gift information; and
transmit the thank you message to a giver computing device of the giver.

2. The system of claim 1, wherein the server further comprises an online gift ordering application for processing an order for the gift, and transmitting the gift message to the recipient computing device.

3. The system of claim 1, wherein the server is further executed to:
obtain the gratitude information from another server managed by a merchant sponsoring the gift purchased by the giver, the other server processing the transaction for, and facilitating transmission of the gift message to the recipient computing device; and
transmit the generated thank you message the other server, wherein the other server transmits the thank you message to the giver computing device.

4. The system of claim 1, wherein the gift message includes a hyperlink that, when selected by the recipient, instructs the thank you message processing application to generate the GUI to receive gratitude information from the recipient.

5. The system of claim 4, wherein the gift message comprises an applet that, when the hyperlink is selected, communicates with the thank you message processing application to generate the GUI to receive the gratitude information from the recipient computing device, the gift message comprising an email message.

6. The system of claim 4, wherein the hyperlink includes code such that, when selected, the hyperlink instructs the recipient computing device to launch a mobile application to communicate with the thank you message processing application to generate the GUI to receive user-supplied content from the recipient computing device, the gift message comprising an short messaging service (SMS) message or a multimedia messaging service (MMS) message, and the recipient computing device comprising a portable computing device.

7. The system of claim 6, wherein the portable computing device comprises at least one of a smart phone and a tablet computer.

8. The system of claim 1, wherein the thank you message processing application is further executed to perform a financial transaction for the thank you message with the recipient computing device.

9. The system of claim 1, wherein the gift information comprises user-supplied content including at least one of audio content, textual content, photographic content, or video content associated with the gift.

10. The system of claim 1, wherein the gift information comprises occasion information associated with the gift, and include the occasion information in the thank you message.

11. The system of claim 1, wherein the thank you message is generated from a template comprising at least one element of occasion based content.

12. The system of claim 1, wherein the gift comprises an online gift.

13. A thank you message generation method comprising:
generating, using at least one processor executing instructions stored in a memory, a graphical user interface (GUI) on a display of a recipient computing device of a recipient to receive gratitude information directed to a giver of a gift, the gift received via a gift message received by the recipient computing device;
extracting, using the processor, at least one element of gift information from the received gift message;
generating, using the processor, a thank you message using the gratitude information and the gift information; and
transmitting, using the processor, the thank you message to a giver computing device of the giver.

14. The method of claim 13, instructing the processor to generate the GUI to receive gratitude information from the recipient in response to selection of a hyperlink included in the gift message.

15. The method of claim 13, further comprising performing a financial transaction for the thank you message with the recipient computing device.

16. The method of claim 13, wherein the gift information comprises user-supplied content including at least one of audio content, textual content, photographic content, or video content associated with the gift.

17. The method of claim 13, wherein the gift information comprises occasion information associated with the gift.

18. A mobile application comprising:
an instance of the mobile application stored in at least one memory of a portable computing device operated by a recipient of a gift, the instance executed by at least one processor of the portable computing device to:
generate a graphical user interface (GUI) on a display of the portable computing device to receive gratitude information directed to a giver of the gift received via a gift message received by the recipient computing device;
extract at least one element of gift information from the received gift message;
generate a thank you message using the gratitude information and the gift information; and
transmit the thank you message to a giver computing device of the giver.

19. The mobile application of claim 18, wherein the gift message includes a hyperlink that, when selected by the recipient, instructs the instance of the mobile application to generate the GUI to receive gratitude information from the recipient.

20. The mobile application of claim 18, wherein the gift information includes at least one of textual content, photographic content, or video content associated with the gift.
